(19) United States
(12) Patent Application Publication
(10) Pub. No.: US 2008/0020250 A1
(43) Pub. Date: Jan. 24, 2008

(54) Storage System for Storing a Medium and Method for Loading a Storage System With a Storage Medium and Emptying the Same Therefrom

(76) Inventors: Walter Schuetz, Weidenberg (DE); Florian Michl, Raubling (DE); Wolfgang Polifke, Freising (DE); Ricardo Paggiaro, Munchen (DE)

Correspondence Address: KRIEGSMAN & KRIEGSMAN, 30 TURNPIKE ROAD, SUITE 9, SOUTHBOROUGH, MA, 01772, US

(21) Appl. No.: 10/578,172

(22) PCT Filed: Nov. 4, 2004
(86) PCT No.: PCT/DE04/02441

§ 371 Date: Apr. 19, 2007

(30) Foreign Application Priority Data
Nov. 5, 2003 (DE) 10351500.3

(51) Int. Cl. H01M 8/04; H01M 2/00

(52) U.S. Cl. 429/26; 429/34

(57) ABSTRACT

The invention concerns, among other things, a storage system (40) for storing a medium, particularly an adsorption storage system for adsorbing a medium, comprising a storage vessel (10) inside of which a storage material (30) for storing, particularly for adsorbing a medium, is provided, and comprising a vessel connection (15) for loading/emptying the storage vessel (10). In order to be able to realize an efficient supply of energy and/or removal of energy, the invention provides that at least one circulation circuit (41) is provided for the storage medium by means of which a removal of energy and/or supply of energy ensues in the storage vessel (10). In addition, the storage medium serves as an energy carrier, and the storage vessel (10) is at least temporarily integrated in the circulation circuit (41). The invention also relates to a method for loading a storage system (40) with a storage medium and emptying the same therefrom.

The present invention first of all relates to a storage system for storing a medium according to the preamble of patent claim 1. In addition, the invention relates to a method for loading a storage medium into a storage system and emptying the same therefrom according to the preamble of patent claim 14.

Such a storage system may be constructed, for example, as an adsorption storage system for adsorbing a medium and may have a storage vessel, which can be constructed, for example, as a so-called adsorption storage unit. Of course, the invention is not limited to this specific application. Basically, the storage system according to the present invention can be applied to any type of storage in which a storage vessel is utilized—in particular one consisting of an inner vessel and an outer vessel, in order to take up a medium to be stored, for example, a gas, a liquid, or possibly even to be filled with a solid.

For clarification, the invention will be described below, however, primarily based on an adsorption storage system.

In particular, the present invention relates to the technical field of hydrogen storage, which has recently attained considerable importance.

Hydrogen is viewed as a zero-emission fuel (with respect to emissions of toxic gases or process gases that influence climate), since when it is used, for example, in thermal internal combustion engines, in fuel cell applications or the like, only water is produced. Consequently, the creation of suitable storage means for the efficient storage of hydrogen is an important objective that must be achieved before hydrogen can find widespread use as a fuel.

It is already known in general to adsorb hydrogen onto carbon-based adsorption materials, also called adsorbents. Such adsorption materials involve activated carbon, for example. In light of the present invention, adsorption means the addition or adsorption of gases or dissolved substances onto the interface of a solid or liquid phase, the adsorption material. The adsorption material thus serves as a storage material for the hydrogen.

The storage material is preferably accommodated in a storage vessel, the adsorption storage unit, in which the hydrogen is stored.

Hydrogen is removed via desorption. The latter is the reverse reaction of adsorption. When the process of adsorption is indicated in the further course of the description, the process of desorption, of course, shall always be taken into consideration as well. In the case of desorption, the hydrogen adsorbed on the adsorption material is released from the adsorption material by introducing energy.

The problem with the adsorption of media on adsorption materials often lies in the management of the reaction heats that occur, that is, adsorption energies or desorption energies that accompany adsorption or desorption, respectively. Thus, local cooling or overheating of the adsorber material may occur or the kinetics of adsorption or desorption, respectively, may be blocked, since adsorber materials, such as activated carbon, for example, with their large specific surface, only poorly conduct heat. Convection as a means of heat transport in the gas phase is also greatly limited due to the large losses on the pore walls of the adsorber material due to friction.

As has already been stated above, adsorber materials are for the most part very porous, that is, they possess a large specific surface. They are thus very poor heat conductors. Now, if hydrogen or another gas is adsorbed thereon, then adsorption heat arises, which in turn causes the material to heat up so that the adsorbed gas is partially desorbed again. Consequently, one must try to transport the heat away from the material. An analogous situation also applies to desorption. In this case, heat must be brought to the adsorption materials in order to bring about the desorption.

In addition, in the case of the previously known, initially mentioned storage vessels, the heat transfers to the connections, for example, to a vessel connection for loading/emptying the storage vessel represents an essential problem. The latter basically form heat leaks, since here, for example, the outer vessel is joined directly in a mechanical manner with the inner vessel. A direct heat transfer or heat conduction, respectively, is thereby possible.

In order to store gases by means of adsorption—in particular on so-called high-surface materials—the temperature of the storage system as well as of the storage medium, for example, a gas, must be reduced to the so-called cryogenic range in order to achieve better storage capacities. This requires the discharge of a large amount of energy. In addition, the energy released by the adsorption of storage medium still is present and this also must be discharged. In contrast, to expel the storage medium, energy must be delivered to the storage system in order to raise its temperature to the room temperature range and in order to provide the necessary desorption energy.

In order for both of these dynamic processes of the storage system to be able to occur as rapidly as possible, an efficient energy input and an efficient energy discharge are necessary.

The problem of the present invention is to develop a storage system as well as a method of the type named initially in such a way that an efficient energy input and an efficient energy discharge, respectively, can be realized.

The problem is solved according to the invention by the storage system with the features according to the independent patent claim 1, the method with the features according to the independent patent claim 14, as well as the uses according to the invention according to the independent patent claims 19 and 20. Other advantages, features and details of the invention result from the subclaims, the description, as well as the drawings. Features, advantages and details, which are described in connection with a specific aspect of the invention, also are applicable each time, of course, to each of the other aspects of the invention.

According to the first aspect of the invention, a storage system is provided for storing a medium, in particular an adsorption storage system for adsorbing a medium, with a storage vessel, in which a storage material is provided for storing, in particular for adsorbing a medium, and with a vessel connection for loading/emptying the storage vessel. This storage system is hereby characterized according to the invention in that at least one circulation circuit is provided for the storage medium, by means of which energy can be drawn off from the storage vessel and/or can be input into it, that the storage medium serves as the energy carrier and that the storage vessel is integrated in the circulation circuit, at least temporarily.

A fundamental feature consists of the fact that the medium to be stored, for example, a gas to be adsorbed—e.g., hydrogen—with the good heat transport properties intrinsic to it, is used as the energy carrier. For this purpose, the storage vessel, in which the medium* (the adsorbent) is found, is integrated at least temporarily in a circulation circuit of the medium to be stored. The circulation circuit may advantageously contain other structural members, which will be explained in more detail in the further course of the description. *sic; storage material?—Translator's note

In order to store media, e.g., gases, by means of adsorption on so-called high-surface materials, the temperature of the storage system as well as of the medium to be stored is advantageously reduced to the so-called cryogenic range in order to achieve higher storage capacities. This cryogenic range lies advantageously in the range of the temperature of liquid nitrogen (T=77 K), since good efficiencies relating to ecological, economic and plant engineering aspects can be achieved at this temperature. Also, the heat of adsorption, which is released during the process of storing the storage medium, for example from hydrogen, can now be rapidly discharged in an approximate manner.

For cooling and/or heating the storage medium to a specific temperature, advantageously at least one heat exchanger may be provided in the circulation circuit.

For example, at least one heat exchanger can be provided in the circulation circuit for cooling the storage medium. In the loading process, the storage medium, e.g., a gas, is cooled with liquid nitrogen (LN₂) in the heat exchanger.

In another embodiment, at least one heat exchanger can be provided in the circulation circuit for heating the storage medium. In the emptying process, the storage medium can be advantageously heated by means of this heat exchanger, for example, with the use of environmental air, the off-heat of an energy converter or the like.

Depending on the embodiment in each case, one individual heat exchanger can be used for cooling and another one for heating. It is also possible, of course, that with an appropriate embodiment of the heat exchanger, only a single heat exchanger is necessary, by means of which the storage medium can be both heated as well as cooled.

After the cooling or heating, respectively, in the heat exchanger, the storage medium is introduced into the storage vessel, wherein the vessel's storage space (inner space) containing the storage material, free space and vessel walls will be heated or cooled, respectively. The storage medium is circulated in the circulation circuit until the desired temperature is reached.

In the case of cooling the storage medium, the storage vessel in which the medium to be stored is found, for example, is integrated in the circulation circuit, which in addition has at least one heat exchanger that can be operated cryogenically. In the heat exchanger, the storage medium that flows through during the storing process—e.g., the adsorption—is cooled to cryogenic temperatures, whereby the storage medium that flows through may also be present in the liquid phase. During the flow through the storage vessel, heat is withdrawn from the heat capacities in the storage space and, just like the heat of adsorption, is discharged in the outflow.

In the same way, the kinetics of the desorption can be improved by the recirculation of cryogenically stored gas, which can also be taken from the gas phase that coexists in the pores, especially at the beginning of desorption, and is heated in the heat exchanger.

Air heat exchangers, which withdraw the heat from the environmental air flowing past, are advantageously considered as heat exchangers for heating. In this case, the flow can be induced both by an outer compulsion, such as, for example, a gust of wind or ventilation as well as also by natural convection. In the same way, off-heat from the consumer, or from the fuel cell or internal combustion engine or even from a gas turbine or the like, which is not utilized, can be transferred to the recirculating storage medium directly or also by means of the heat transfer bypass to a heat carrier via a heat exchanger. The heat capacity stored in the gas is introduced into the storage vessel, whereby the vessel's inside space containing the parts adsorbent and free-gas space including tank walls is cooled or heated, respectively. In order to maintain a constant gas flow to the consumer, the pipelines that lead out from the storage vessel are advantageously shaped in such a way that both the requirements of the consumer will be sufficiently complied with and it will also be assured that the heat flow which is again introduced into the system via the backflow of the storage medium, for example, hydrogen, equilibrates the quantity of heat withdrawn from the environment in the desorption. That is, if the system is left to itself for the desorption, without the input of heat, the temperature inside the system will be clearly reduced. In the case of the adsorbent/adsorbate combination AC-H2, temperature drops of>20 K are characteristic. With the indirect proportionality between temperature and storage capacity, due to this decrease in temperature, another gas would be bound to the surfaces of the adsorbent, whereby sooner or later, the gas flow to the consumer would be exhausted.

In another embodiment, at least one transporting device, for example a pump or similar device, can be provided in the circulation circuit. The storage medium is preferably circulated by means of such a transporting device, which can be connected upstream and/or downstream from the at least one heat exchanger.

Advantageously, the storage vessel can have at least one other vessel connection for loading and/or emptying the storage medium, by means of which the storage medium can be later filled or removed, respectively.

In the case of the previously known, initially mentioned storage vessels or adsorption storage units, respectively, the heat transfers to the connections, for example, to a vessel connection for loading/emptying the storage vessel represents a basic problem. These connections basically form heat leaks, since here, for example, the outer vessel is joined directly in a mechanical manner with the inner vessel. A direct heat transfer or heat conduction, respectively, is thereby possible.

Advantageously, therefore, in the case of a storage vessel with an inner vessel for the medium to be stored, an outer insulating vessel, as well as a vessel connection for loading/emptying the inner vessel, it can be provided that the vessel connection has an inner connection piece connecting the inner vessel and an outer connection piece connecting the outer vessel, and that a coupling is provided, which is configured in such a way that a separable coupling is produced or can be produced between the inner connection piece and the outer connection piece.

In another embodiment, it may also be provided that the storage vessel has an inner vessel for the medium to be stored as well as an outer insulating vessel, that at least one heat bridge that can be engaged and disengaged is provided between the inner vessel and the outer vessel, and that the at least one heat bridge is configured in such a way that for the purpose of the heat exchange, a thermal connection is produced or can be produced, at least temporarily, between the inner vessel and the outer vessel.

Therefore, a vessel connection can be provided that produces a mechanical connection between the inner vessel and the outer vessel only when needed. That is, during the loading and emptying of the storage vessel, for example a refueling system, a connection between the inner vessel and the outer vessel will be produced via a coupling.

The invention is not limited to a specific embodiment of the coupling. The coupling will generally involve a type of closing mechanism, which, when actuated, produces a connection between inner vessel and outer vessel, so that access to the storage space of the inner vessel is made possible. Several nonexclusive examples of suitable types of couplings are explained in more detail in the further course of the description.

During storage, if nothing is removed from or introduced into the storage vessel, the inner vessel is mechanically decoupled from the outer vessel and can therefore be optimally insulated against external heat influences. If the medium stored in the storage vessel is required by a consumer connected downstream, the coupling will be actuated and a suitable gas line will be coupled by means of coupling the inner connection piece and the outer connection piece. In addition to the introduction or discharge, respectively, of the medium, this also makes possible a heat conduction via the corresponding heat-conducting pipe walls.

Likewise or alternatively, it is also possible to engage heat bridges between the inner vessel and the outer vessel that are suitable according to the above-described principle, in order to support, for example, the necessary introduction of heat for the removal of the medium, for example, of hydrogen.

Advantageously, it may be provided that the storage vessel has, in addition, at least one heat bridge that can be engaged and disengaged between the inner vessel and the outer vessel, and that the at least one heat bridge is configured in such a way that for the purpose of heat exchange, a thermal connection is produced or can be produced, at least temporarily, between the inner vessel and the outer vessel.

The purpose of such a heat bridge consists of producing a defined conduction of heat between the inner vessel and the outer vessel, when needed.

For example, heat can be introduced into the inner vessel from the outside. Such a procedure is meaningful when the medium must be desorbed from a storage material found in the vessel when the medium is removed, for which purpose activation energy is required. When the ambient temperature of the outer vessel is lower than the temperature within the inner vessel, a discharge of heat from the inner vessel also can be produced, of course, in this way.

The present invention is not limited to a specific number of heat bridges. The suitable number is rather a result that depends on the quantity of heat to be introduced or drawn off, respectively. Therefore, embodiments are definitely conceivable, in which the storage vessel has two or more such heat bridges. Likewise, the invention is not limited to a specific embodiment of the heat bridge(s). Several nonexclusive examples will be explained in more detail for this purpose in the discussion below.

Advantageously, an intermediate insulation space can be formed between the inner vessel and the outer vessel. The at least one heat bridge that can be engaged is then disposed preferably in this intermediate insulation space. For example, a vacuum can be formed in the intermediate insulation space. Alternatively or additionally, however, it is also possible that an insulation material is provided in the form of an insulating gas, in the form of a powder insulation or a foil insulation or similar means, in the intermediate insulation space.

Preferably, it can be provided that the inner wall and/or the outer wall of the inner vessel and/or of the outer vessel is/are coated or covered with an insulating material, in particular with an insulating foil, at least in regions. In another embodiment, the vessel connection can also be covered with an insulating material, in particular with an insulating foil, at least in regions.

An increase in the degree of freedom of the inner vessel is also associated, for example, with the mechanical decoupling of the inner vessel and outer vessel, as described above.

The fixing of the inner vessel in space, that is, its orientation and bearing can be produced advantageously by means of filling the evacuated intermediate insulation space with powder insulation, either completely or partially. A combination employing insulating foil windings—especially of a super-insulating kind—is possible, when appropriate support elements based on powder insulation are packed in vacuum-tight foils and thus are separated from the environment in a gas-tight manner.

It may be advantageously provided that the coupling between the inner connection piece and the outer connection piece is designed for mechanical or pneumatic or magnetic coupling. A nonexclusive example of a suitable coupling will be explained in more detail below for this purpose.

It may be provided, for example, that the coupling between the inner connection piece and the outer connection piece is designed for magnetic coupling. In such case, for example, the inner connection piece may be formed of a magnetic material or have a magnetic material, at least in regions. In addition, a device for generating a magnetic field can then be provided, wherein, for generating the magnetic field, a separable coupling is produced or can be produced between the inner connection piece and the outer connection piece.

The device for generating a magnetic field may comprise, for example, an electromagnet, which will be turned on when needed. The use of permanent magnets is, of course, also possible, which, when needed, are brought into a desired position, for example, rotated or pivoted.

When the magnetic field is activated, the inner connection piece is pulled in the direction of the outer connection piece, so that a connection is formed from the outside to the inside of the inner vessel. When the coupling between inner vessel and outer vessel is to be disengaged, the magnetic field is deactivated, whereupon the inner connection piece is separated from the outer connection piece.

In order to support or to carry out this separation process, a restoring spring can be advantageously provided for the inner connection piece.

The advantageous embodiment of the at least one heat bridge will be explained in more detail below.

Preferably, the heat bridge can be designed so that it can be actuated mechanically or pneumatically or magnetically. Also in this respect, an advantageous, non-exclusive example of embodiment of a heat bridge will be explained in more detail below.

For example, the heat bridge can be designed so that it can be actuated magnetically. The heat bridge preferably has a heat-conducting element, which is formed of a magnetic material or has a magnetic material, at least in regions. In addition, a device for generating a magnetic field is provided, wherein, for generating the magnetic field for purposes of heat exchange, a thermal connection is produced or can be produced, at least temporarily, between the inner vessel and the outer vessel.

The heat-conducting element is first attached to the inner vessel. For example, this element may be made of a good heat-conducting material, e.g., copper or the like, which is either also magnetic, e.g., ferromagnetic, or is combined with a magnetic material. The heat-conducting element is first found on the outer surface of the inner vessel. When a magnetic field is applied, in particular an external magnetic field, the heat-conducting element is swung toward the outside up to the inner surface of the outer vessel, whereupon a thermally conductive connection results between inner vessel and outer vessel.

As soon as the magnetic field is deactivated, the heat-conducting element is released from the outer vessel and returns to its initial position, which corresponds to an interruption of the thermal connection. In order to support or carry out this separation, the heat bridge can advantageously have at least one restoring spring for the heat-conducting element.

If the storage system, as it is described above, is constructed as an adsorption storage system and the storage vessel is an adsorption storage unit, this advantageously provides a storage material on which the medium to be stored, for example, hydrogen, can be adsorbed. Therefore, a storage material for adsorbing a medium can be advantageously provided in the inner vessel.

Several detailed features relative to the storage material will be described below.

For example, it is conceivable that the storage material is structured in the form of one or more pressed composites of storage material.

Advantageously, a composite material for adsorbing a medium can be provided as a storage material, wherein the composite material contains an adsorption material based on carbon and wherein the adsorption material contains admixtures at least of one additive material with high thermal conductivity.

The invention, however, is not limited to specific values for thermal conductivity. It is important only that the thermal conductivity of the additive material is greater than that of the adsorption material. Several nonexclusive examples of suitable additive materials are explained in more detail in the further course of the description.

A fundamental feature consists of adding admixtures of material with high thermal conductivity to the adsorption material. These material admixtures are mixed with the adsorption material and do not negatively influence the adsorption properties, nor the desorption properties, of course, nor the diffusion of gas, nor the diffusion of medium. A positive influencing may be produced, of course. However, these admixtures specifically bring about an essential improvement in the thermal conductivity of the material even when added in an amount of only a few percent. This leads to the fact that the heats of reaction that occur can be equilibrated basically more rapidly, and for example, the loading and emptying process, e.g. a refueling process or the delivery of gas from a storage vessel can occur essentially more rapidly.

The present invention is not limited to a specific percent quantity of additive material in the adsorption material. It has been demonstrated as advantageous if the quantity of additive material is less than/equal to 10 wt. %, preferably less than/equal to 5 wt. %, particularly preferred less than/equal to 3wt. %, each referred to the quantity of adsorption material. It is particularly preferred if the quantity of additive material amounts to 1.5 wt. %, or to approximately 1.5 wt. %.

It may be provided advantageously that the additive material forms a network structure, in particular a three-dimensional network structure, in the adsorption material. In this way, for example, as will be explained in more detail in the further course of the description, the stability and/or the conductivity, i.e., the thermal or electrical conductivity, of the composite material will be further improved.

For example, it may be provided that the adsorption material is structured in the form of pure and functionalized graphite and/or in the form of material with graphite-like carbon structure and/or in the form of activated carbon.

Of course, other materials are also conceivable for the adsorption material. It is important only that it is based on carbon.

The additive material to be used may be constituted in the most varied manner, so that the invention is not limited to specific materials. Several non-exclusive, advantageous examples of suitable additive materials, however, will be described below. For example, only a single material may be used as the additive material. Of course, different materials, which can then be combined with one another, may also form the additive material.

Advantageously, it may be provided that the additive material is structured in the form of at least one nanoscale additive. For example, the additive material may be a carbon nanomaterial and/or a carbon micromaterial. The carbon micromaterial involves a material that has particles whose dimensions lie in the micrometer range. The carbon nanomaterial involves a material that has particles whose dimensions lie in the nanometer range. Such carbon materials possess a high thermal conductivity, are light in weight and may be simply introduced into the adsorption material. They are also able to adsorb a small amount of the medium, for example, hydrogen.

It may be advantageously provided that the carbon nanomaterial and/or the carbon micromaterial is/are structured in the form of carbon fibers and/or carbon tubes. Such materials, in particular, show good thermal conductivity.

If carbon nanotubes will be used, these can be formed, for example, as so-called single-wall carbon nanotubes (SWNT) or multi-wall carbon nanotubes (MWNT). Both types are also available in modifications with a metal or semiconducting coating. The metal modifications should be used advantageously, since these possess a high thermal conductivity and also a high electrical conductivity. In addition, carbon nanofibers are also possible, of course, whose electrical and thermal conductivity is somewhat smaller in comparison to that of carbon nanotubes. In addition, so-called carbon nanoshells can also be utilized.

Advantageously, the carbon nanomaterial and/or the carbon micromaterial may be utilized in the form of oriented material, or, however, it may have a directed structure. In a preferred embodiment, the materials are formed in helical shape. This helical-form structure may be described, for example, as the shape of a “spiral staircase”. The helical-form structures may first have an outer structure running in a longitudinal direction in the form of a helical line and, in addition, an internal structure. This inner structure, which would form the individual stairs in the example of the “spiral staircase”, comprises individual carbon planes. Such a structure has considerable advantages due to the many edges involved.

Advantageously, the additive material can be pretreated in such a way that it contributes at least to a small extent to the adsorption of the medium.

Preferably, the composite material may contain at least one other additive in order to increase the stability of the composite material. This additive may also involve, for example, the carbon materials described previously. Carbon nanomaterials or carbon micromaterials, respectively, can in fact bring about an increase in the mechanical stability of the composite material. Because of this, in addition to carbon nanotubes, for example, carbon nanofibers (so-called herringbone fibers or platelet fibers or other modifications, such as, for example, helical-shaped carbon nanofibers) are also considered.

In order to improve the mechanical and/or thermal and/or electrical properties of the composite material, it is also possible to introduce a combination of different types of carbon micromaterials or nanomaterials, respectively, (e.g., fibers and tubes) into the adsorption material.

In addition, by targeted modification, it is possible to increase the electrical and/or thermal conductivity of the additive materials, for example, of carbon nanotubes and nanofibers. This is carried out, for example, by a thermal post-treatment after the synthesis of the materials (for example, heating to approximately 1000° C. under inert conditions). Defects in the material are reduced by such a treatment.

It can be advantageously provided that the additive material is/will be chemically modified in order to improve the binding with the adsorption material. In this way, a good binding will be produced between the adsorption material and the additive material. This can be accomplished, for example, by functionalization (introduction of suitable side groups to the additive materials). Here, attention must be paid to the fact that the initially desired properties of the additive materials (good conductivities and mechanical stability) are not adversely affected.

Preferably, it can be provided that at least one flow channel for the medium to be adsorbed is provided in the composite material. In order to assure attractive refueling times and a uniform distribution of pressure and temperature in the pressure tank, it is additionally advantageous to provide sufficiently large flow channels through the storage material.

In order to be able to realize adsorption storage units, which are described further below, advantageously, the composite material is brought to a specific form. Several nonexclusive examples will be explained below in this respect.

Frequently, the adsorption material is present as a powder and, in order to be able to use it in a technical system, it must first be pressed into a composite, e.g., in the form of pellets, granulate and the like. The adsorption material is now mixed with the additive material prior to the pressing process. Additionally, it may be advantageous to also introduce other additives (for example, binders or the like) in order to increase the stability of the additive material or composite, respectively.

By means of a suitable composition of the additive material added to the adsorption material, a three-dimensional network is advantageously constructed, which prevents a collapsing of the microporosities or nanoporosities, respectively, during the pressing process, e.g., a pelleting process. By means of the additive materials, for example carbon nanofibers or carbon nanotubes, the free spaces will protect intrinsic high strengths and elasticities, similar to a supporting framework.

Advantageously, the composite material may consequently be structured in the form of at least one pressed composite. It can be provided that the pressed composite has at least one flow channel for the medium to be adsorbed. In order to assure attractive refueling times and a uniform distribution of pressure and temperature in a storage vessel, which may involve, for example, a pressure tank, it is additionally advantageous to provide sufficiently large flow channels through the storage material. It may be provided alternatively that the crude shape of the pressed product is configured in such a way that the flow of gas can occur in the hollow spaces. The same functionality may also be produced by filling up the entire cross section of the adsorption storage unit with the pressed products, but there will also be one, and preferably several, through-passages that are permeable to the gas flow. Intermediate spaces or even boreholes will be axially distributed in rows one after the other over the periphery in order to prevent a short circuit of the gas flow from occurring. Rather, in this way, the recirculating gas is guided along on the surfaces of the front sides of the adsorbent, whereupon the probability of an interaction between solid and gas is increased. A meaningful ratio of the cross sections of composite material to flow channels lies, for example, between 2:1 and 4:1.

Advantageously, the composite material can be made into the form of pellets and/or granulate and/or a granulate packing and/or a powder packing, whereby the invention is not limited, of course, to the named examples.

Advantageously, the storage vessel contains a storage material in the form of one or more pressed composites of composite material. In particular, the latter may contain a storage material in the form of two or more pressed composites of composite material, whereby the height of the composite amounts to five to ten times the diameter of the composite.

In another embodiment, it may be provided that the storage system and here, in particular, the storage vessel, has a device for conducting an electrical current through the storage material. By conducting an electrical current through the storage material (for example, a mixture of additive material and adsorption material), desorption can be facilitated. This electrical current causes a heating up of the material (resistance heating). The additive materials, in particular carbon nanotubes, are also very good electrical conductors. By means of introducing carbon nanotubes, for example, in activated carbon (a common adsorber material, which may bring about too strong an electrical insulating effect), the total electrical resistance of the system can be controlled in a targeted manner. This is effected by varying the content and the distribution of nanotubes in the adsorber material. Therefore, a material with a defined electrical resistance can be produced.

Preferably, a device for generating and inputting microwaves into the storage material can also be provided. In the case of desorption, the desorption energy must be input. The inputting of microwave heating is another possibility, in addition to the already described possibilities with gas convection, heat conduction and electrical heating. The basic advantage in this case is to be able to locally limit the energy that is input to the adsorbtion material. The energy is transported from there to the adsorbed storage medium. Of decisive importance for inputting microwaves is the type and morphology of the material receiving the microwaves. Here, attention must be paid to the fact that carbon materials, or materials that are based on carbon compounds, are well suitable, in principle, for being heated with microwaves. Microwaves can be input particularly well into carbon materials or materials that are based on carbon compounds, respectively. On account of the poor input relative to metal materials, the heat capacities of the adsorption storage unit will not operate, which, on the one hand increases the efficiency of the heat input, and, on the other hand, reduces the boil-off losses due to subsequent input of heat from the heat capacities. The input of microwaves is also well possible with nanomaterials based on carbon, particularly CNFs and CNTs (carbon nanofibers, carbon nanotubes). An advantageous possibility for energy input as well as an acceleration of the desorption thus result, which are associated with good thermal conductivity.

According to another aspect of the invention, a method is provided for loading/emptying a storage medium into/from a storage system, which has a storage vessel, in which the temperature is reduced, at least in the storage vessel, for the loading of the storage vessel, and in which the temperature is increased, at least in the storage vessel, for emptying the storage medium from the storage vessel. This method is characterized according to the invention in that the temperature is adjusted within one circulation step, in which the storage medium is transported through the storage vessel by means of a circulation circuit and that the storage medium serves as the energy carrier, by means of which energy is withdrawn from the storage vessel and/or input into it.

Advantageously, the method can have steps for operating a storage system according to the invention as described above, so that reference is made to the above discussion relative to it.

Also advantageously, the method can be used for loading/emptying an adsorption storage system.

Preferably, when the storage vessel is loaded, the storage medium can be cooled in the circulation circuit and then can be introduced into the storage vessel. In another configuration, when the storage vessel is emptied, the storage medium can be heated in the circulation circuit and then can be introduced into the storage vessel.

A storage system according to the invention as described in more detail above can be used, in particular, for the storage of hydrogen. Also, a method according to the invention, as described above, can be used, in particular for loading/emptying hydrogen into/from a storage system. Of course, the invention is not limited to the storage of hydrogen. Thus, other media, in particular, gases, can also be stored with the present invention.

In particular, the present invention may be a component of a system for mobile hydrogen storage, in particular in vehicles with an integrated energy converter used for private and public transport.

The present invention is particularly advantageous also with respect to energy.

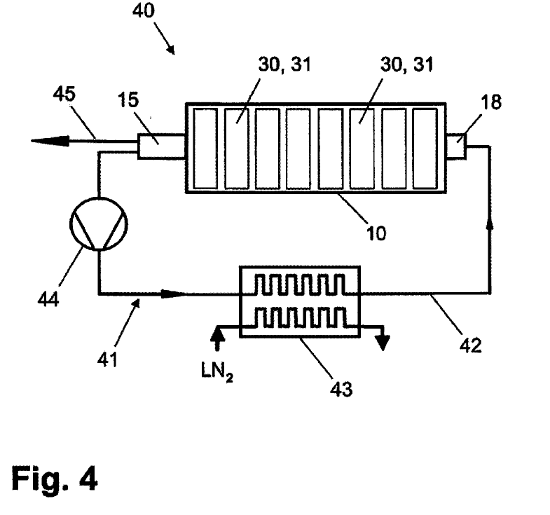

Typical operating conditions for adsorbing hydrogen are p=40 bars und T=77 K. Simulated values for different scenarios will be described below for this configuration. The configuration of the construction of the apparatus thereby corresponds to the storage system presented in FIG. 4.

Due to the fact that a large part of the energy does not reach inside the vessel, but is discharged outside in the heat exchanger (or, as long as the hydrogen will not be back-cooled again there), the devices therein for heat transport can be designed correspondingly for lower efficiency. This promises advantages with respect to volume and weight.

In the energy balance, for the heat capacities of the storage vessel and the storage material (activated carbon or other highly porous storage materials), approximately 400 and 1000 to 1500 kJ are applied each time, if a tank that can take up 6 kg of hydrogen is assumed. This is a typical size for the required range of operation and similar applications.

For activated carbon, the adsorption heat makes up the largest part of the energy balance sheet (>10,000 kJ). For other materials—for example, nanotubes—this amount is reduced correspondingly.

The hydrogen serves for the transport of energy out from the storage vessel; the difference in the enthalpies is calculated against the sum of the above partial energies, since the enthalpy of the hydrogen also increases due to the heating inside the storage vessel (enthalpy difference of approximately 5000 kJ). Care should be taken to change this value as a function of the adsorbent or of the adsorption heat belonging to it.

Approximately 7500 kJ thus results in the balance, and this must be discharged from the tank.

In contrast to this, the “static” finding, i.e., the cooling of hydrogen to 77 K in the tank—inclusive of adsorption heat, would mean a heat quantity of e>13,000 kJ in the sum, since the enthalpy of the gas that flows in must also be considered.

One could now propose for the operation that the temperature of the recirculating hydrogen would be adjusted to 50 K, for example, in order to accelerate the logarithmic approximation to the 77 K at the end of filling and thus also the entire filling process.

For example, the total weight of storage material (composite material) in the storage vessel (adsorption storage unit) can amount to approximately 100-130 kg for the goal of storing 6 kg of hydrogen in the storage vessel (adsorption storage unit). This corresponds to a gravimetric storage density of approximately 4.5 to 9 weight percent.

The invention will be explained below in more detail based on the embodiment examples with reference to the attached drawings. Here:

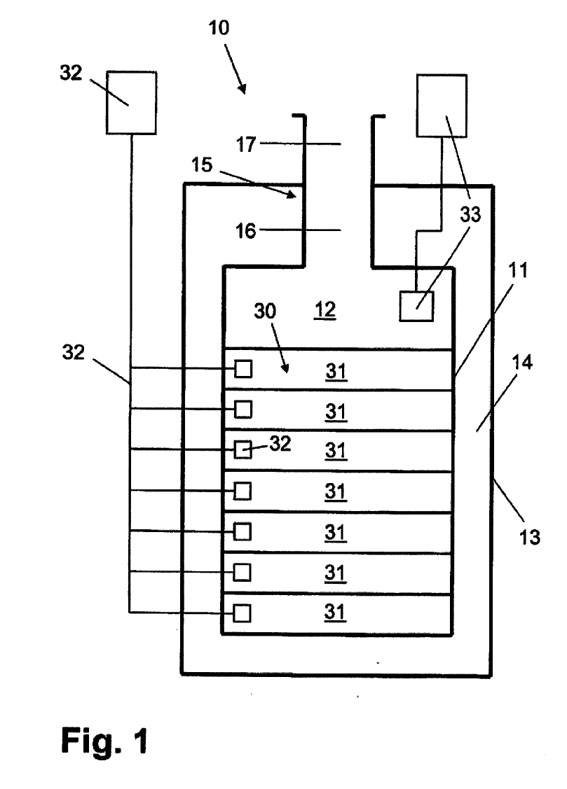

FIG. 1 shows in schematic view a storage vessel in the form of an adsorption storage unit, which is filled with storage material in the form of a composite material;

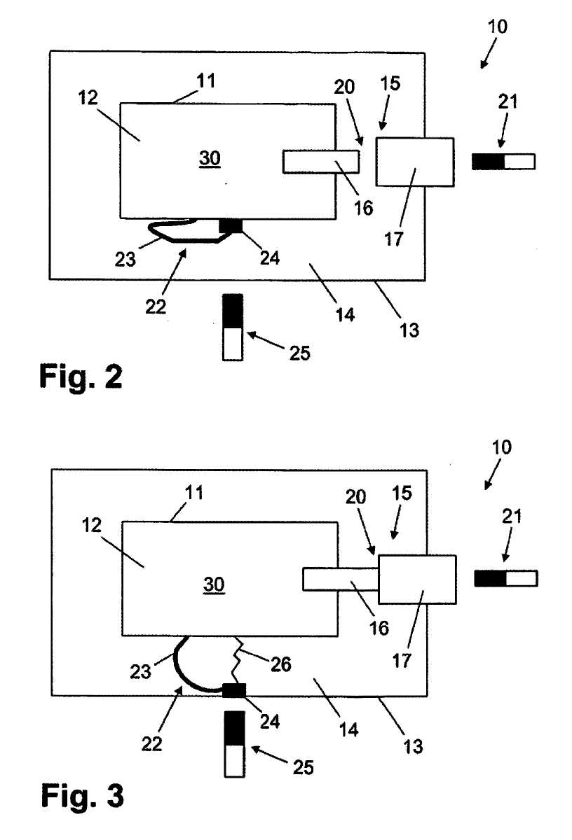

FIGS. 2 and 3 show in schematic view a storage vessel in the form of an adsorption storage unit, in which the inner vessel can be decoupled from the outer vessel; and

FIG. 4 shows in schematic view a storage system with a storage vessel in the form of an adsorption storage unit, in which the adsorption storage unit is integrated into the circulation circuit of the medium to be stored, at least temporarily.

In each of FIGS. 1 to 4, a storage vessel 10 is shown, which shall serve for storing hydrogen. For this purpose, storage vessel 10 is filled with a storage material 30, to which the hydrogen is adsorbed. Storage vessel 10 thus involves an adsorption storage unit, for example a hydrogen tank. When the hydrogen is to be removed from storage vessel 10, this is performed by way of desorption, which involves a kind of reverse reaction of adsorption.

The storage vessel 10 first provides an inner vessel 11, in the storage space 12 of which is disposed the storage material 30. In addition, the storage vessel 10 provides an insulating outer vessel 13. Between inner vessel 11 and outer vessel 13 there is found an intermediate insulation space 14, in which a suitable insulation material can be found. The storage vessel 10 is loaded and emptied via a vessel connection 15. The vessel connection 15 provides an inner connection piece 16 assigned to the inner vessel 11 as well as an outer connection piece 17 assigned to the outer vessel 13. The two pieces are coupled with one another at least temporarily, as will be explained in more detail in connection with FIGS. 2 and 3.

The storage material 30 may be present in the form of one or more pressed composites 31 and can be taken up in storage vessel 10 or in its storage space 12. For example, the pressed composites 31 may involve pellets, granulate and the like.

According to one aspect of the present invention, it is possible to improve the thermal conductivity of the storage material 30.

The problem with the adsorption of media on adsorption materials often lies in the management of the reaction heats that occur, that is, adsorption energies or desorption energies in the case of adsorption or desorption, respectively. Thus, the kinetics of adsorption or desorption, respectively, can be blocked, since the highly porous adsorbtion materials, for example, activated carbon with its high specific surfaces only possesses insufficient heat-conducting properties. Convection as a means of heat transport in the gas phase is also greatly limited due to the large losses on the pore walls due to friction. In order to prevent this, admixtures of material (additive material) with high thermal conductivity, preferably nanomaterials or micromaterials based on carbon are added to the adsorption material.

Thus a storage material 30 is provided, which is formed as a composite material, comprised of an adsorption material based on carbon as well as admixtures of at least one additive material with high thermal conductivity. In this case, the additive material will have a thermal conductivity that is at least greater than the thermal conductivity of the adsorption material.

Due to the high aspect ratio of carbon microfibers and nanofibers, in particular nanotubes (CNT), the thermal conductivity is increased due to the formation of a network, without essentially reducing the storage capacity of storage material 30 due to the low percolation threshold (typically 1 to 5 wt. %). With an appropriate pretreatment, the CNTs also contribute in a smaller extent to the storage.

Based on the uniqueness of adsorption as a basic physical principle, a large amount of energy is released during the transition process from the gaseous to the adsorbed phase, typically approximately 1.5 kJ/mol for CNT and 6 kJ/mol for processed activated carbon. In contrast to liquid-gas storage, the enthalpy necessary for the phase change cannot be withdrawn from the gas phase. The energy fluxes arising on site must be discharged as rapidly as possible to the environment in order to achieve a short filling time. In addition to the macroscopic heat conduction from the interface between the surface of the storage material and the environment, in the case of nanoporous storage materials 30—as described above—in particular, the microscopic or nanoscopic heat transfer, respectively, is of great importance for the kinetics of loading the storage vessel 10. In particular, in the case of pressed storage material 30 in the form of pressed composites 31 in granulate or pellet form with the large flow resistances that are typical of these composites to the gas flow inside storage material 30, it is possible to overcome the relatively large distance between the site of the adsorptive input of the medium to be stored, e.g., hydrogen, and the macroscopic discharge of heat.

A homogeneous distribution of temperatures in the powder or granulate packings of storage material 30 also acts positively on the total kinetics of the process by avoiding “hot spots”. The coupling between individual particles via an impressed nanofiber network fulfills this function in cooperation with heat transport in a gaseous medium. This applies also, in particular, to compressed powder or granulate packings.

By suitable composition of the additive materials mixed with the storage material 30, a three-dimensional network is formed, which prevents the collapsing of the microporosities and nanoporosities, for example, during a pelleting process. By means of the CNFs (carbon nanofibers) and CNTs (carbon nanotubes), the free spaces will protect intrinsic high strength and elasticity, similar to a supporting framework.

The same considerations as those for the adsorption process apply to the desorption with the removal of gas. The support for introducing heat energy here also plays an essential role as does also the improvement of gas transport. Due to the requirements on the part of possible consumers connected to the storage system, it is necessary to pump the medium (adsorbate) that is stored if needed from storage material 30 (adsorbent) or to introduce the energy, typically in the form of heat, to the adsorbed phase.

In the proposed storage system, emptying is preferably to be conducted by means of introducing heat, as is described in the following. The occurring reaction heats can also be equilibrated essentially more rapidly in the case of desorption by means of the thermal conductivity of the admixed additive materials.

In addition, a device 32 for conducting an electrical current through the composite material 30 may be provided advantageously. By conducting an electrical current through the composite material 30 (a mixture of additive material and adsorption material), the desorption can be facilitated. This electrical current causes a heating up of the material (resistance heating). The additive materials, in particular carbon nanotubes, are also very good electrical conductors. By means of introducing carbon nanotubes, for example, in activated carbon (a common adsorber material, which may bring about too strong an electrical insulating effect), the total electrical resistance of the system can be controlled in a targeted manner. This is carried out by varying the content and the distribution of nanotubes in the adsorber material. Therefore, one must produce a material with a defined electrical resistance.

Alternatively or additionally, a device 33 for generating and introducing microwaves into the composite material 30 can also be provided. In the case of desorption, the desorption energy must be input. The inputting of microwave heating is another possibility, in addition to the already described possibilities with gas convection, heat conduction and electrical heating. The basic advantage here is to be able to locally limit the input of energy to the adsorbtion material. The energy is transported from there to the adsorbed storage medium.

An advantageous construction of a storage vessel 10 is presented in FIGS. 2 and 3, the basic structure of which corresponds first to the storage vessel 10 presented in FIG. 1, so that reference is made to the corresponding detailed description.

The basic problem with cryotanks, which typically consist of an inner vessel 11 and an outer insulating vessel 13, involve heat transfers to the vessel connections 15. The vessel connections 15 represent substantial heat leaks, since the inner vessel 11 is joined with the outer vessel 13 in a direct mechanical manner, so that a direct heat conduction is possible.

In FIGS. 2 and 3, a vessel connection 15 is presented, which produces a mechanical connection between the inner vessel 11 and the outer vessel 13 only when needed.

The vessel connection 15 is formed of an inner connection piece 16 assigned to the inner vessel 11 and an outer connection piece 17 assigned to the outer vessel 13. In addition, a coupling 20 is provided, which is formed in such a way that a separable coupling can be produced between the inner connection piece 16 and the outer connection piece 17. Advantageously, the coupling 20 can be constructed as a magnetic coupling.

In this case, first of all, a device 21 is provided for generating a magnetic field. In addition, the inner connection piece may be formed of a magnetic material or, however, contain a magnetic material, at least in regions. Now when a magnetic field is generated, the inner connection piece 16 is pulled in the direction of the outer connection piece 17, so that the two pieces 16, 17 are coupled and thus a vessel connection 15 arises, through which the inner vessel 11 or its storage space 12, respectively, can be loaded and/or emptied. For example, the inner connection piece 16 can still be equipped with a restoring spring (not shown), by means of which the inner connection piece 16 will be restored to an initial position separately from outer connection piece 17, as soon as the magnetic field is turned off. Of course, other types of couplings 20 are also conceivable.

That is, during the refueling and emptying from the storage vessel 10—for example by means of a magnetic or pneumatic coupling 20—a connection is produced between the inner vessel 11 and the outer part of the tank. An increase in the degree of freedom of inner vessel 11 is associated with this mechanical decoupling. The fixing of the inner vessel 11 in space, that is, its orientation and bearing can be produced advantageously by means of filling the evacuated intermediate space 14 with powder insulation, either completely or partially. A combination with super-insulating foil insulation windings is possible, when appropriate support elements based on powder insulation are packed in vacuum-tight foils and thus are separated from the environment in a gas-tight manner.

During the storing itself, thus when nothing is being removed from the storage vessel 10, for example a tank, the inner vessel 11 is mechanically decoupled from the outer vessel 13 and thus can be optimally insulated against external heat influences. If the medium that stores energy—for example, hydrogen—is required by the consumer, the coupling 20, which generally involves a type of closing mechanism, is actuated and the corresponding gas lines (not shown) are coupled. This makes possible, in addition to the introduction and discharge of gas, the conduction of heat via the heat-conducting pipe walls.

Likewise, the connection of at least one heat bridge 22 is possible with the above-described mechanism, which supports the necessary introduction of heat for the removal of hydrogen.

Such a heat bridge 22 is first of all comprised of a heat-conducting element 23, which is connected to the inner vessel 11. In addition, the heat-conducting element 23 can be comprised of magnetic material, or, however, as shown in FIGS. 2 and 3, can have a head 24 of magnetic material on its free end facing away from the inner vessel 11. In turn, a device 25 for generating a magnetic field is provided. Now if a magnetic field is generated, the magnetic head 24 of the heat-conducting element 23 will be pulled, so that a thermal connection between inner vessel 11 and outer vessel 13 will be produced via the heat-conducting element 23, which may comprise copper, for example, or another material with good heat-conducting properties. By this means, a heat exchange can now be produced. If the magnetic field is turned off, the heat bridge 22 will be disengaged by releasing the heat-conducting element 23 from the outer vessel 13. This process can be carried out or supported, respectively, by a suitable restoring spring 26.

In addition, a storage system 40, for example a refueling system and a method for introducing and discharging energy, particularly in cryogenic adsorption storage systems, will also be described. Such a storage system is shown in FIG. 4.

The storage system 40 first provides a storage vessel 10, in which a storage medium 30, e.g., in the form of pressed composites 31, is found. The storage vessel 10 is loaded/emptied via a vessel connection 15, which is connected to a consumer by means of an appropriate line 45. Refer also to the detailed discussions relative to FIGS. 1 to 3 for the basic construction of the storage vessel 10.

In order to store gases by means of adsorption on high-surface materials, the temperature of the system as well as of the gas will be reduced to a cryogenic range in order to achieve better storage capacities. This cryogenic range lies advantageously in the range of the temperature of liquid nitrogen (T=77 K), since good efficiencies relating to ecological, economic and plant engineering aspects can be achieved in this range.

Since heat of adsorption will arise, which will be released during the storing of hydrogen, it must be rapidly withdrawn in an appropriate manner. The method described below makes this possible. The fundamental feature of this method is that the gas to be adsorbed, and preferably this is hydrogen with the good heat transport properties intrinsic to it, is used as the energy carrier.

For this purpose, the storage vessel 10, in which is found the medium* to be stored (adsorbent), is integrated into a circulation circuit 41, for example, which contains in turn at least one transporting device 44 in the form of a pump as well as at least one heat exchanger 43—preferably which can also be operated cryogenically. The individual components of the circulation circuit 41 are combined with one another via a suitable circulation line 42. This is shown in FIG. 4. An additional vessel connection 18 can be provided in storage vessel 10 in circulation circuit 41 in order to refill or to remove the storage medium (hydrogen). *sic; storage material?—Translator's note

The gas is circulated in the circulation circuit 41 preferably by means of a pump 44, which is connected upstream or downstream to the heat exchanger 43. The gas that flows through during the adsorption is cooled to cryogenic temperatures in heat exchanger 43, wherein a phase transformation to the liquid phase is also not excluded. During the flow through the storage vessel 10, heat is withdrawn from the heat capacities in the storage space and, just like the heat of adsorption, is discharged in the outflow. Cooling can be carried out, for example, by means of liquid nitrogen (LN₂), which is guided through the heat exchanger 43.

In the same way, the kinetics of the desorption can be improved by the recirculation of cryogenic gas, which will be taken from the gas phase that coexists in the pores, and is heated in the heat exchanger 43. Air heat exchangers, which withdraw the heat from the environmental air flowing past, are considered, for example, as heat exchanger 43. In this case, the flow can be impressed both by an outer compulsion, such as, for example, a gust of wind or ventilation as well as also by natural convection. In the same way, off heat from the consumer, from a fuel cell or an internal combustion engine or even from a gas turbine, which is not utilized, can be transferred to the recirculating storage medium directly or also by means of the heat transfer bypass to a heat carrier via heat exchanger 43. The heat capacity stored in the gas is introduced into the storage vessel 10, whereby its inside space 12 including the parts: storage material 30, free-gas space including tank walls is cooled or heated, respectively (see FIGS. 1 to 3).

The heat exchanger 43 for cooling and heating can be formed as two separate units, depending on the embodiment each time. Of course, only one single heat exchanger 43 may also be used, which can assume both functions of cooling and heating.

In order to maintain a constant gas flow to the consumer, the pipelines 42, 45, which lead out from the storage vessel 10, are shaped in such a way that both the requirements of the consumer will be sufficiently complied with and it will also be assured that the heat flow which is again introduced into the system via the backflow of the hydrogen will equilibrate the quantity of heat withdrawn from the environment in the desorption. That is, if the system is left to itself for desorption, without the input of heat, the temperature inside the system will be clearly reduced. In the case of the adsorbent/adsorbate combination AC-H2, temperature drops of>20 K are typical. With the indirect proportionality between temperature and storage capacity, due to this decrease in temperature, another gas would be bound to the surfaces of the adsorbent, whereby sooner or later, the gas flow to the consumer would be exhausted.

In order to assure attractive refueling times and a uniform distribution of pressure and temperature in storage vessel 10, it is additionally necessary to provide sufficiently large flow channels through the storage material 30. In the same way, it may be provided that the crude shape of the pressed composite 31 (pressed product) is configured in such a way that the gas can flow into the hollow spaces. The same functionality may also be produced by filling up the entire cross section of the storage vessel 10 with the pressed products 31, provided that there is one, and preferably there are several, through-passages that are permeable to the gas flow. By axially distributing intermediate spaces or even boreholes in rows one after the other over the periphery, a short circuit of the gas flow will be prevented from occurring. Rather, in this way, the recirculating gas is guided along on the surfaces of the front sides of the adsorbent, whereupon the probability of an interaction between solid and gas is increased.

A meaningful distribution of the cross sections of storage material 30 and flow channels is 2:1 to 4:1. Since the length of the entire system of flow channels enters proportionally into the flow resistance, an advantageous, but not necessarily geometric partitioning of the storage space is meaningful. The length or height, respectively, of individual logic segments (individual pressed composites 31) is thus preferably to be limited to five to ten times the diameter of the pressed composites 31.

### LIST OF REFERENCE NUMBERS

10 Storage vessel (adsorption storage unit)
11 Inner vessel
12 Storage space
13 Outer vessel
14 Intermediate insulation space
15 Vessel connection
16 Inner connection piece
17 Outer connection piece
18 Vessel connection
20 Coupling (magnetic coupling)
21 Device for generating a magnetic field
22 Heat bridge
23 Heat-conducting element
24 Head of magnetic material
25 Device for generating a magnetic field
26 Restoring spring
30 Storage material (composite material)
31 Pressed composite of storage material
32 Device for conducting an electrical current through the storage material
33 Device for generating and introducing microwaves into the storage material
40 Storage system
41 Circulation circuit for the storage medium
42 Circulation line
43 Heat exchanger
44 Transporting device (pump)
45 Line to the consumer

1. A storage system for storing a medium, in particular an adsorption storage system for adsorbing a medium, with a storage vessel, in which a storage material is provided for storing, particularly for adsorbing a medium, and with a vessel connection for loading/emptying the storage vessel, hereby characterized in that at least one circulation circuit is provided for the storage medium, by means of which energy can be drawn off from the storage vessel and/or can be input into it, that the storage medium serves as the energy carrier and that the storage vessel is integrated in the circulation circuit, at least temporarily.

2. The storage system according to claim 1, further characterized in that at least one heat exchanger is provided in the circulation circuit, in order to bring the storage medium to a predetermined temperature.

3. The storage system according to claim 2, further characterized in that at least one heat exchanger is provided in the circulation circuit for cooling the storage medium.

4. The storage system according to claim 2, further characterized in that at least one heat exchanger is provided in the circulation circuit for heating the storage medium.

5. The storage system according to claim 1, characterized in that at least one transporting device is provided in the circulation circuit.

6. The storage system according to claim 1, further characterized in that the storage vessel has at least one other vessel connection for loading and/or emptying the storage medium.

7. The storage system according to claim 1, further characterized in that the storage vessel has an inner vessel for the medium to be stored, an outer insulating vessel as well as a vessel connection for loading/emptying the inner vessel, that the vessel connection has an inner connection piece connecting to the inner vessel and an outer connection piece connecting to the outer vessel and that a coupling is provided, which is configured in such a way that a separable coupling is produced or can be produced between the inner connection piece and the outer connection piece.

8. The storage system according to claim 1, further characterized in that the storage vessel has an inner vessel for the medium to be stored, as well as an outer insulating vessel, that at least one heat bridge that can be engaged and disengaged is provided between the inner vessel and the outer vessel, and that the at least one heat bridge is configured in such a way that, for the purpose of heat exchange, a thermal connection is produced or can be produced, at least temporarily, between the inner vessel and the outer vessel.

9. The storage system according to claim 1, further characterized in that a storage material for adsorbing a medium is provided in the storage vessel.

10. The storage system according to claim 9, further characterized in that the storage material is structured in the form of one or more pressed composites of storage material.

11. The storage system according to claim 9, further characterized in that a composite material for adsorbing a medium is provided as the storage material, that the composite material contains an adsorption material based on carbon and that the adsorption material contains admixtures at least of one additive material with high thermal conductivity.

12. The storage system according to claim 9, further characterized in that a device for conducting an electrical current through the storage material is provided.

13. The storage system according to claim 9, further characterized in that a device for generating and introducing microwaves into the storage material is provided.

14. A method for loading/emptying a storage medium into/from a storage system, which has a storage vessel, in which the temperature is reduced at least in the storage vessel for the loading of storage medium into the storage vessel, and in which the temperature is increased at least in the storage vessel for emptying the storage medium from the storage vessel, hereby characterized in that the temperature is adjusted within a circulation step, in which the storage medium is transported through the storage vessel by means of a circulation circuit, and that the storage medium serves as the energy carrier, by means of which energy is discharged from the storage vessel and/or input into it.

15. The method according to claim 14, further characterized in that the latter has steps for operating a storage system for storing a medium, in particular an adsorption storage system for adsorbing a medium, with a storage vessel, in which a storage material is provided for storing, particularly for adsorbing a medium, and with a vessel connection for loading/emptying the storage vessel, wherein at least one circulation circuit is provided for the storage medium, by means of which energy can be drawn off from the storage vessel and/or can be input into it, that the storage medium serves as the energy carrier and that the storage vessel is integrated in the circulation circuit, at least temporarily.

16. The method according to claim 14, further characterized in that it is used for loading/emptying an adsorption storage system.

17. The method according to claim 14, further characterized in that when the storage vessel is loaded, the storage medium will be cooled in the circulation circuit and then will be introduced into the storage vessel.

18. The method according to claim 14, further characterized in that when the storage vessel is emptied, the storage medium will be heated in the circulation circuit and then will be introduced into the storage vessel.

19. A use of a storage system according to claim 1 for storing hydrogen.

20. A use of a method according to claim 14 for loading/emptying hydrogen into/from a storage system.
